(19) United States
(12) Patent Application Publication
(10) Pub. No.: US 2025/0001605 A1
(43) Pub. Date: Jan. 2, 2025

(54) PROBABILISTIC AUTOCOMPLETE SYSTEM FOR ROBOT PROGRAMMING

(71) Applicant: Intel Corporation, Santa Clara, CA (US)

(72) Inventors: Javier Felip Leon, Hillsboro, OR (US); David Gomez Gutierrez, Tlaquepaque (MX); Rafael De La Guardia Gonzalez, Guadalajara (MX); David Gonzalez Aguirre, Portland, OR (US); Leobardo Campos Macias, Guadalajara (MX)

(21) Appl. No.: 18/216,187

(22) Filed: Jun. 29, 2023

(51) Int. Cl. B25J 9/16

(52) U.S. Cl. CPC B25J 9/1679; B25J 9/1661; B25J 9/1697

(57) ABSTRACT

Various aspects of techniques, systems, and use cases may be used for probabilistic automatic determination of an action for a robotic device. A technique may include identifying a current context of a robotic device, determining from the current context, a set of actions performable by the robotic device corresponding to at least one object, the set of actions including one or more affordances generated from a basic skills library for the robotic device, and automatically selecting an action of the set of actions based on an acyclic graph describing action paths. The technique may include outputting control signals that, when executed, cause the robotic device to perform the action to interact with the at least one object.

### BACKGROUND

Robots and other autonomous agents may be programmed to complete complex real-world tasks. The field of robotics has developed to use artificial intelligence (AI) technologies to perform tasks in industrial environments, among many other environments. For instance, robotics span a wide range of industrial applications, such as smart manufacturing assembly lines, multi-robot automotive component assembly, computer and consumer electronics fabrication, smart retail and warehouse logistics, robotic datacenters, etc. Often robots interact with humans to complete tasks.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates teleoperation and autocomplete system building blocks for use with a robotic device according to an example.

FIG. 2 illustrates a diagram showing example basic skill representations according to an example.

FIG. 3 illustrates example actions afforded by a screw including relative pose of an end effector for each of the affordances according to an example.

FIG. 4 illustrates an example acyclic affordance graph for a task according to an example.

FIG. 5 illustrates an augmented reality (AR) control interface including suggested actions for a robotic device according to an example.

FIGS. 6A and 6B illustrate flowcharts showing techniques for probabilistic automatic determination of an action for a robotic device according to an example.

FIG. 7A provides an overview of example components for compute deployed at a compute node.

FIG. 7B provides a further overview of example components within a computing device.

### DETAILED DESCRIPTION

Systems and techniques described herein provide probabilistic autocomplete robotic tasks with a robotic device. An autocomplete robotic task may include an affordance, such as one generated from a set of basic skills for the robotic device. The affordance may be selected, such as based on an augmented reality (AR) gesture made by a human, a virtual reality (VR) gesture made by a human, a joystick (e.g., a 6D joystick) input, a game controller input, a marker-based body tracking movement, a markerless body tracking movement, or the like. The affordance may be selected from one or more affordances of an affordance acyclic graph, such as a graph generated for a particular task (e.g., affixing a component to a circuit board).

Robotic teleoperation systems are typically focused on the fine control of the robot joints or end effector. A human may be in control of the fine-grained motion of the end effector or a gripper to demonstrate or perform a manipulation task. This way of controlling robots has the benefit of the fine control of the end effector but has productivity drawbacks. Fine-grained teleoperation tends to be slow and when high precision is required the tasks are cautiously executed by humans resulting in examples that are much slower than average human performance. The systems and techniques described herein provide a technical improvement by leveraging already executed task demonstrations to train a model to learn possible actions an object affords, possible actions a task affords, or how motions are performed. Using a vocabulary of affordances and motions, the systems and techniques described herein may be used to assist a teleoperator to quickly define new previously unseen tasks. In some examples, such as during runtime, a prediction of an intent of a human collaborator to improve task fluency may be output.

When there is a task that uses a new skill or an operator determines that a skill may be improved (e.g., fine tuned to be faster, require less processing, etc.), a system may provide an option to edit an individual action or generate a new action. The operator may take over control, such as disabling a snap-fit option to provide fine grained corrections. Depending on the accuracy of the autocomplete suggestions, the difficulty of the task and the rarity of the actions, tasks may be programmed in a matter of seconds instead of minutes or even hours.

The systems and techniques described herein may identify a probabilistic task, and use an affordance and action joint inference mechanism to propose a top ranked or set of fine-grained actions in real-time or near real-time, such as while the task is being demonstrated. A teleoperation interface may be used to allow the user to seamlessly accept action suggestions from a multiple-choice list or proceed with the fine-grained demonstration.

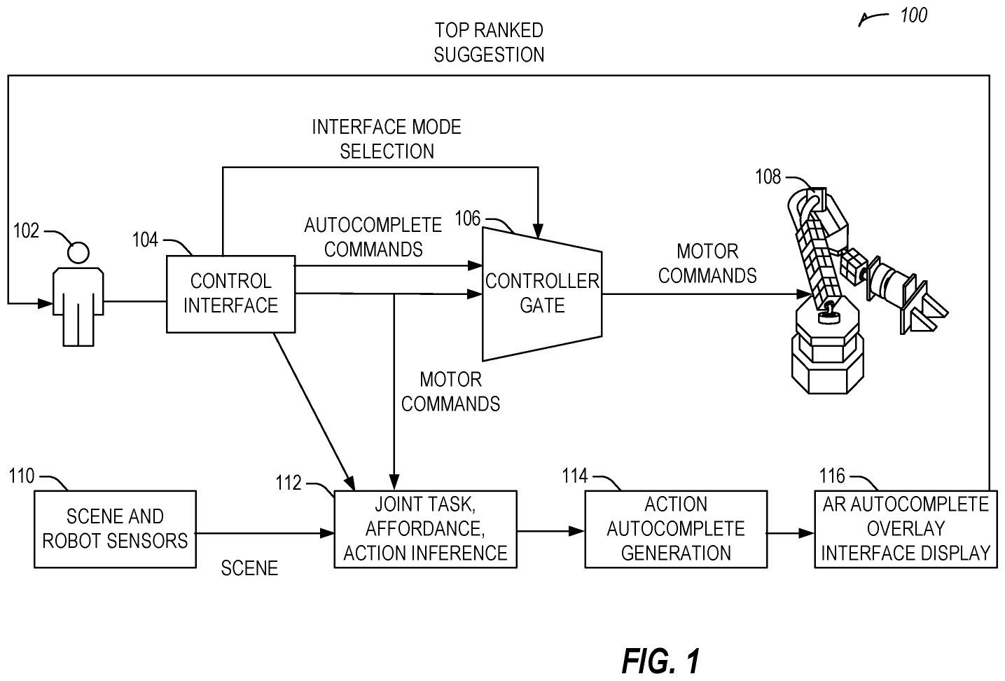

FIG. 1 illustrates teleoperation and autocomplete system building blocks for use with a robotic device according to an example. A system 100 shown in FIG. 1 shows a user 102 and a robotic device 108 (e.g., a robotic arm, a robot, an autonomous device, etc.). The user 102 may use a control interface 104 to effectuate commands to the robotic device 108. The control interface 104 may detect (e.g., via a camera or other sensor) a gesture, movement, or other command (e.g., a movement) by the user 102. The movement by the user 102 may be interpreted by the control interface 104, for example to autocomplete a command, which may be output for display, such as for selection or confirmation by the user 102 or may be used to control the robotic device 108 automatically (e.g., using the controller gate 106). After selection or confirmation, the controller gate 106 may be used to control the robotic device 108. The control interface 104 may include an AR control interface, a VR control interface, a controller, a joystick, or a combination thereof.

The control interface 104 may capture a movement of the user 102, and use a joint task affordance action inference 112 along with captured or entered scene and robot sensor information 110 to determine a context and available affordance for controlling the robotic device 108. An action autocomplete generation component 114 may be used to identify a command from the movement, for example using a trajectory of the movement. An AR autocomplete overlay interface display component 116 may output one or more determined affordances (e.g., based on the context and the command) for display. The user 102 may select or confirm an affordance, as output from the component 114, and the robotic device 108 may be controlled using the affordance to generate a control signal at the controller gate 106.

In some examples, an output affordance may include predictions as a probability function. The predictions may span different actions, affordances, or trajectories that are potentially being performed (e.g., in the movement of the user 102 and the context of the user 102 or the robotic device 108). A set of predictions, for example ranked by probability, may be presented to the user 102 when an action the user is performing is in a list (e.g., stored in a list of actions). The user 102 may accept a suggestion, move to a next step, and avoid finalizing the demonstration. In some examples, the system 100 is used to enhance collaboration. Predictions about the intent of the user 102 may be used to improve task fluency. In some examples, multiple actions may be captured or identified, for example with a prediction horizon longer than a brief movement.

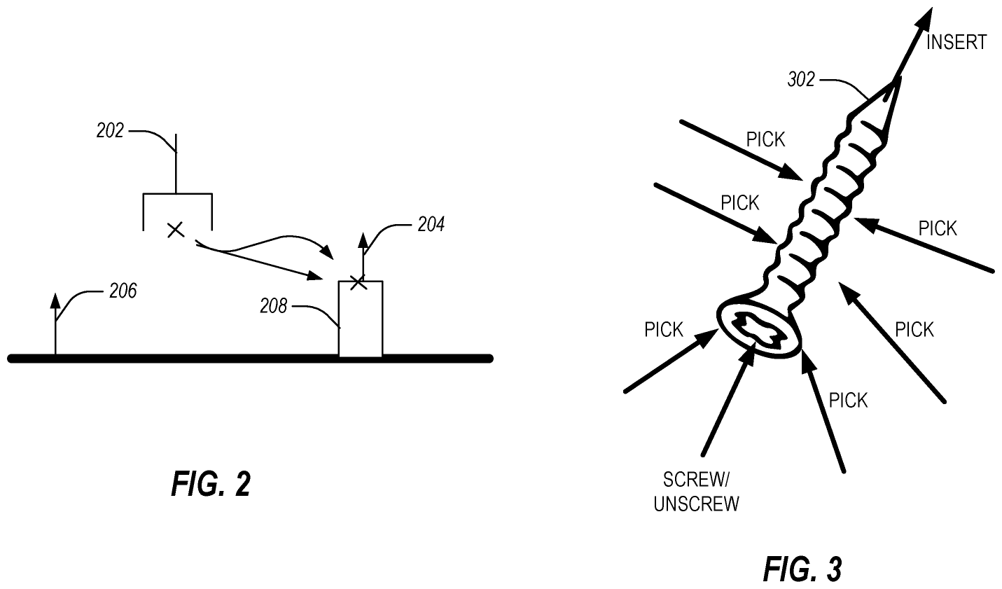

FIG. 2 illustrates a diagram showing example basic skill representations according to an example. FIG. 2 includes a basic skill representation example. The straight arrows represent a global-based 206 task frame and an object-based 208 task frame. An “X” may represent a key point associated with an end effector of a robotic device 202 or an object 204. The arrows from the robotic device 202 to the object 204 depict trajectories for the robotic device 202 that may be generated with a minimum jerk, a Dynamic Movement Primitives (DMP), or according to any other movement characteristic.

A system using the robotic device 202 may be trained, for example at a location where the system is deployed or as part of the development of the system in a pre-training stage. The system may be configured to learn basic action building blocks that maybe embodiment dependent. Specifically, the building blocks may be dependent on each specific robot kinematics and dynamics.

Basic skill learning (BSL) may be performed with the robotic device 202. There are multiple skill representation types that may be used in tele-operation, such as DMP, Probabilistic Movement Primitives (ProMP), Neural Networks, etc. A variety of skills such as different movement styles to complete an ongoing task may be used with the robotic device 202. For example, a library may be created that is parameterized by context, key points, task affordances, etc., such as by using multiple existing representations. Training data, when available, may be used, or zero-shot representations, such as minimum jerk, may be used in some examples. To compose trajectories generated by different representations, a null space projection method may be used.

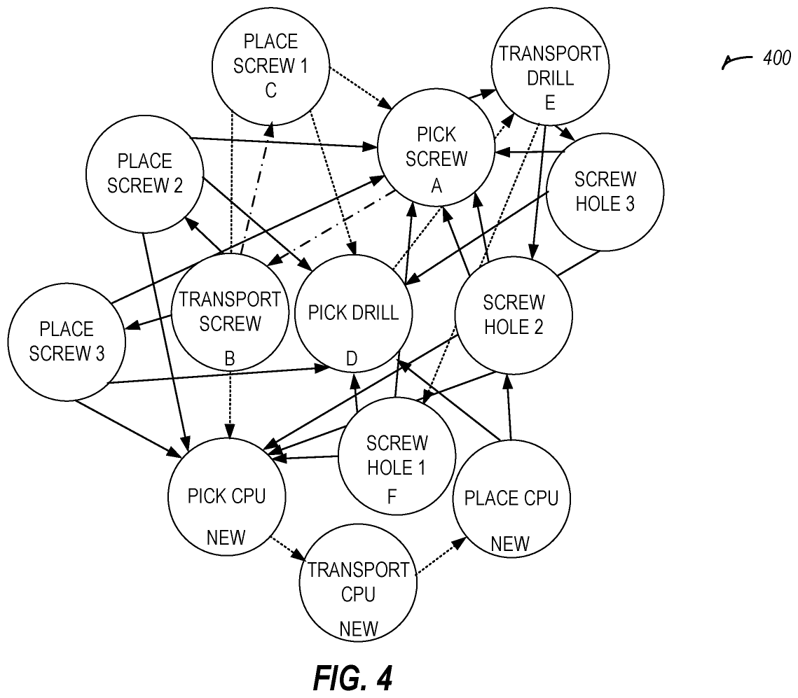

FIG. 3 illustrates example actions afforded by a screw 302 including based on relative pose of an end effector for each of the affordances according to an example. The example affordances in FIG. 3 include picking up the screw 302, inserting the screw 302 (e.g., into a screw hole), and screwing or unscrewing the screw 302. Other actions may be provided in different contexts (e.g., releasing the screw 302). The actions may be based on an orientation of an end effector of a robotic device. For example, the arrows shown in FIG. 3 may represent a trajectory of the end effector. The example affordances shown are representative, and may not actually be shown (e.g., only affordances that are close to the trajectory may be shown, while other of the example affordances are not shown). FIG. 3 shows example actions afforded by a screw based on a relative pose of the end effector that is valid for each of the affordances. In some examples, such as “pick,” an afforded action can be completed from multiple end-effector relative poses, while other afforded actions, such as screw, unscrew, or insert may be limited to only one or a limited range of relative poses.

Object affordances may be defined as a possibility of an action on an object. For example, a screw affords being screwed (or picked up, or placed, or inserted, etc.). When a robotics system uses the affordance concept, how to perform the afforded action may be grounded on specific motor commands (e.g., capabilities of a robotic device). For example, an affordance may include a definition of force required to perform an action (e.g., a range, a value, etc.), a relation of the robot end effector with the object in order to perform the action properly, a trajectory, etc. For example, each object affordance may be satisfied with multiple configurations. A screw may afford one or more of: pick, place, insert, screw, unscrew, drop, or the like. FIG. 3 illustrates different end-effector relative positions that may be used to perform the different afforded actions (e.g., the arrows of FIG. 3). Affordances are object specific, and may be gripper specific (e.g., specific to a particular grip of an end effector of a robot). The object affordances may be extracted depending on object geometry, actions afforded by the object, a gripper being used to perform the tasks, or the like. Object affordances may be extracted automatically from videos of a human or a robot manipulating objects and performing tasks with them. To map the extracted object affordances to the specific robot gripper, affordances may be computed using simulation techniques in combination with grasp planners that may determine whether object-gripper configurations produce stable manipulations. When objects are not known, the concept of affordances may be applied to specific geometric features of unknown objects.

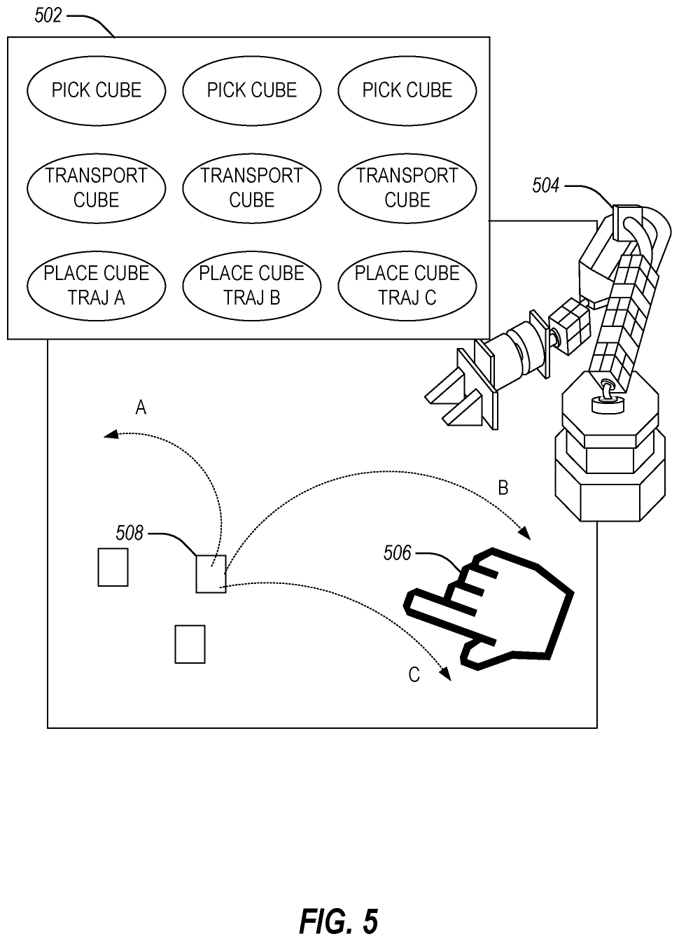

FIG. 4 illustrates an example acyclic affordance graph 400 for a task according to an example. The example affordance graph includes learned graph edges and nodes for an example screw task with a drill. The affordance graph may be built or modified over time, for example by adding a new task, removing a task, adding a new connection, removing a connection, etc. Task affordance extraction and action chains may be generated and stored for use with a robotic device. The affordance graph 400 may be specific to a robotic device, specific to a context or include task chains specific to a task, or the like.

Affordances may be used as nodes of the affordance graph 400, with connections (e.g., edges) being directional in some examples, and representing a next task in a particular set of affordances. The affordances may be generated from basic skills (e.g., as described above). The affordances may be represented with different granularities, such as from an entire task definition to a particular motion configuration trajectory with its radian positions and velocities. These affordances may be represented in the acyclic affordance graph 400, which may be directed, meaning that the connections between nodes may be one way. The nodes of the affordance graph 400 may include a specific task, and the vertices may include possible transitions from each of the tasks.

Defining an affordance graph 400 in this form allows for easily incorporating new tasks, such as at execution time, by identifying a new task (e.g., a new node) and making a properly directed vertex in the graph structure. For example, adding a new task, such as placement of a CPU may be represented by the nodes labeled “NEW” in the affordance graph 400. Adding the new nodes may include also adding the directional edges. The transitions may be learned or specified by hand, and an affordance may include a low-level trajectory that the robot is to execute (e.g., go home). A low-level affordance may coexist with higher-level tasks provided by the vertex connectivity in the graph. In some examples, the affordance graph 400 may be used to assemble a computer.

The affordance graph 400 may be used to obtain possible outcomes (e.g., action chains or affordance-paths) for a robotic device. An observation window may be defined, such as where human actions are related to states (e.g., a node) and transitions (e.g., a vertex) from the affordance graph 400, along with the goals or outcomes detected at the training stage. A K-best search graph algorithm may be used to provide a set of solutions from the current state for the achievable goals. The solutions may be used to display actions a robotic device may complete, for example for a user to accept or select to complete the task.

In some examples, goal prediction may improve with more task observations. The task affordance extraction may complete a path, such as from “pick screw A” to “screw hole 1 F,” along a path from “pick screw A” to “transport screw B” to “place screw 1 C” to “pick drill D” to “transport drill E” to “screw hole 1 F.” In this example, the path formed may define a desired task of a user (e.g., to screw a screw into hole 1). As shown in the affordance graph 400, same or similar affordance tasks from the robot perspective (e.g., place a screw, screw, etc.) may be separately labeled in the affordance graph 400 for different locations or contexts (e.g., hole 1, hole 2, or place screw 1, place screw 2, place screw 3). In these examples, the screws may not be independently considered (although, for picking a screw, the particular screw may be specified by where the robotic device is), for example any screw may go in any hole in some examples, while holes may be specified since they are in different end locations. Thus, the “pick screw” step may be used as a starting affordance for ultimately screwing in three different screws into three different holes.

Using the observation window, the affordances may be stacked, such as “pick a screw,” “transport screw,” and “place screw 1”. The last action may be used as a starting node, and the possible finalization task as a goal, such as “place CPU,” “pick screw,” and “screw hole 1”. The action chains may include a path to finding solutions from the start to the goal, which may be used for a user to determine whether the robot may complete the task. The next observed state may be nominated when a user does not select the first option, which may be used to reduce the possible task action ending and provide a more accurate path. Observed action chains may be stored in a dataset for further learning or updating to probabilistic relations between the different objects and affordances. The probabilistic relations may be stored with data related to a state of the robot or the environment, an object, the task being performed, previous actions, or the like.

In an example, user teleoperation motion may be received, and a set of ranked suggested actions or action chains may be output. The output may be displayed to the user (e.g., in AR), as autocomplete candidates. The user motion may be captured by a camera or other sensor. The user motion may be used to generate a probability distribution of possible affordance-object action pairs (e.g., from the affordance graph 400). The intent of the user may be predicted and aligned to the possible actions that may be executed. An inference may be influenced by incorporation of other context, such as cues that carry information about a possible next action. For example, previous actions, current task, object positions may be used to weight probabilities of next actions. For example, object affordances may be used in a prediction pipeline. The trajectory that the user operator is teaching to the robot may be predicted, and an affordance used may be predicted. In some examples, based on the prediction, an action may snap to a pre-generated relative end-effector pose that is compatible with the predicted affordance. For example, the user does not need to align exactly with the affordance or action of the robot, but instead an affordance or action may be predicted (or a set of probabilities may be predicted) based on the user being within a threshold distance, angle, trajectory, or alignment. The threshold may be used to determine a probability (e.g., 75% closer to gesture A than gesture B may be indicative of a 90% likelihood that affordance A corresponding to gesture A is the correct affordance).

In an example, an inference to determine a likely next affordance includes making a set of reaching target hypotheses, generating possible trajectories that reach the targets, and comparing the possible trajectories with sensor data (e.g., from a robotic device) to rank the possible trajectories according to likelihood. The likely trajectories may be ranked or filtered (e.g., excluding ones that are below a threshold likelihood). In an example, the dimensionality of the inference space may be increased to include an affordance action label. In an example, the generated trajectories may be forced to “snap” to the end-effector poses relative to the object for an affordance. The number of hypotheses to evaluate may be greatly reduced using these two example adjustments, and an inference may be sped up. An output may include a probability distribution over affordances for each object. For example, each pair object-affordance may be labeled with a probability of being the next action to be performed.

An autocomplete action generation may be used, for example by automatically generating action candidates by sampling from the task distribution. This may be conditioned on the teleoperation trajectory being performed or a previously executed action. By sampling multiple times, a sequence of actions may be suggested as an autocomplete action chain that may be accepted or rejected by the operator.

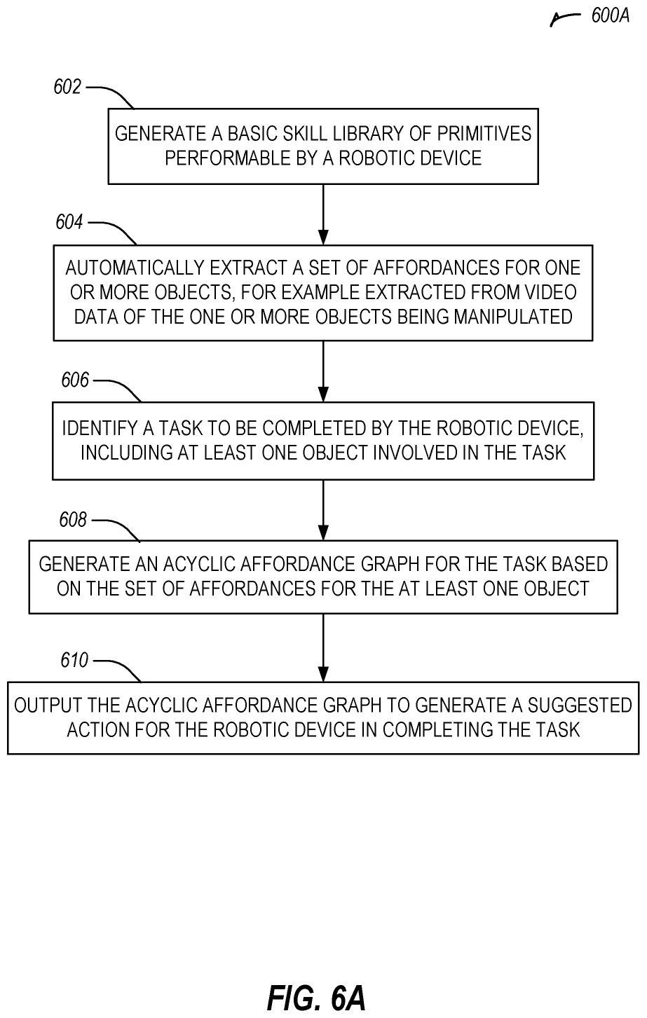

FIG. 5 illustrates an augmented reality (AR) control interface including suggested actions for a robotic device according to an example. An AR control interface may be used for controlling a robotic device 504. A user may control an end effector of the robotic device 504 to perform a pick action on a cube for example cube 508. A hand trajectory 506 of a user may be determined for predicting an affordance for the robotic device 504. A predicted intent may be used to generate one or more action chain suggestions. The one or more action chain suggestions may be displayed in a virtual display or on a physical display, such as at user interface 502. The user interface 502 in the example of FIG. 5 shows three different pick, transport, and place options with three different trajectories, which correspond to trajectories A, B, and C shown in relation to the cube 508. The user may examine the proposed autocomplete actions, for example as overlaid in the AR display at user interface 502, and decide whether to accept a suggestion and continue with the next steps of the program.

The augmented reality control interface may be used to overlay a current state of the robotic device 504, or other information, such as a current estimated state of the environment, the candidate actions, or the like. The augmented reality control interface may capture a user command, for example via a handheld controller or a hand gestures (e.g., corresponding to hand trajectory 506) to teleoperate the robotic device 504, such as by using a fine-grained position control or to browse or accept suggested action autocompletions.

The user may indicate that fine-grained control is being performed, for example through sustained activation of a “TELEOP” signal, which may be encoded as a hand gesture or by pressing and holding a trigger on a handheld device, for example. While in TELEOP mode, actions may be proposed and their representations may be overlaid on top of operator field of view (e.g., in user interface 502). The operator may trigger an “ACCEPT” signal through a controller or hand gesture, for example to accept the first ranked action proposed. Another option may include stopping the “TELEOP” signal, browsing through the proposed actions, selecting an action, reactivating the “TELEOP” signal to continue with the fine-grained robot control, or the like.

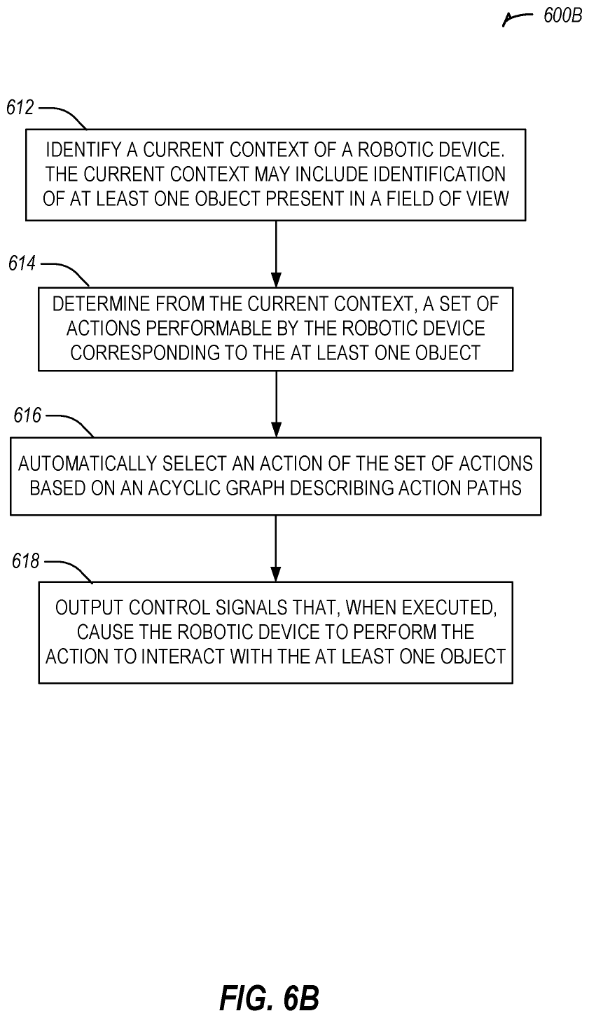

FIGS. 6A-6B illustrate flowcharts showing techniques 600A and 600B for probabilistic automatic determination of an action for a robotic device according to an example. The techniques 600A-600B may be performed by a computing device (e.g., including processing circuitry), by a robotic device, etc. The technique 600A includes generating an acyclic affordance graph and technique 600B shows use of the acyclic affordance graph. Techniques 600A and 600B may be used together or separately. For example, one entity may generate the acyclic affordance graph and another entity may use the acyclic affordance graph.

The technique 600 includes an operation 602 to generate a basic skill library of primitives performable by a robotic device. The technique 600 includes an operation 604 to automatically extract a set of affordances for one or more objects, for example extracted from video data of the one or more objects being manipulated (e.g., by a robotic device or a human). The set of affordances may be specific to an orientation of the one or more objects. The technique 600 includes an operation 606 to identify a task to be completed by the robotic device, including at least one object involved in the task.

The technique 600 includes an operation 608 to generate an acyclic affordance graph for the task based on the set of affordances for the at least one object. The acyclic affordance graph may include at least one action that is only available when at least one other action has been completed. The acyclic affordance graph may include weights assigned to affordances of the acyclic affordance graph. The technique 600 includes an operation 610 to output (e.g., store, display, send, etc.) the acyclic affordance graph to generate a suggested action for the robotic device in completing the task.

The technique 600 includes an operation 612 to identify a current context of a robotic device. The current context may include identification of at least one object present in a field of view. The current context may include identification of all objects that are in a field of view, a trajectory of the robotic device, a task to be completed, or the like.

The technique 600 includes an operation 614 to determine from the current context, a set of actions performable by the robotic device corresponding to the at least one object. The set of actions may include one or more affordances generated from a basic skills library for the robotic device. The set of actions may be generated by automatically extracting tasks from video or image data captured of the robotic device. The basic skills library may include one or more dynamic movement actions including at least one of grasping an object, moving an object, releasing an object, or the like.

The technique 600 includes an operation 616 to automatically select an action of the set of actions based on an acyclic graph describing action paths. The action may be contingent, for example based on a previously performed action by the robotic device. Operation 616 may include determining that two or more actions of the acyclic graph are selectable based on the current context, and selecting the action based on a probability of each of the two or more actions.

The technique 600 includes an operation 618 to output control signals that, when executed, cause the robotic device to perform the action to interact with the at least one object. The robotic device may be controlled using a gesture via an augmented reality interface, a virtual reality interface, a joystick (e.g., a 6D joystick) input, a game controller input, a marker-based body tracking movement, a markerless body tracking movement, or the like. The gesture may be displayed in the AR interface, the VR interface, on a display screen, or the like. The current context may include identification of the gesture or other input. The technique 600 may include receiving user confirmation of the action before outputting the control signals.

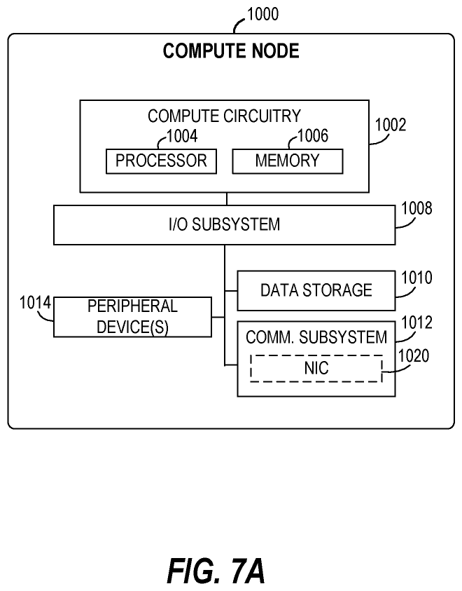

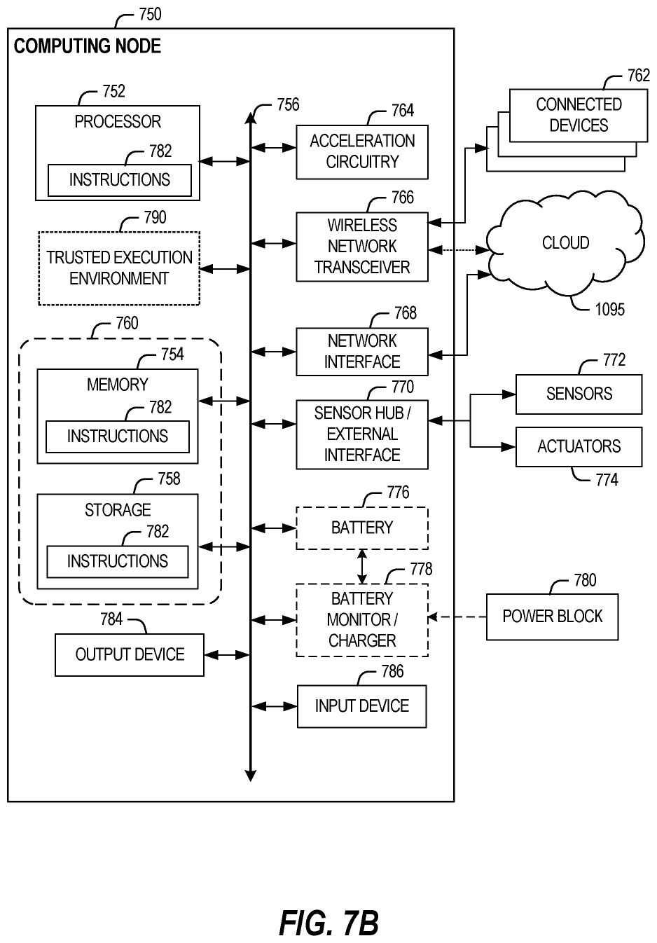

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, a processing unit, a specialized or special purpose processing unit, or other processor or processing/controlling circuit.

In some examples, the processor 704 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 704 may work in coordination with each other to execute many types of operations and instructions within and on behalf of the compute node 700.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., a gateway of an implementing computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., a gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective compute node (whether a client, gateway, or aggregation node) in a computing system or like forms of appliances, computers, subsystems, circuitry, or other components.

In a more detailed example, FIG. 7B illustrates a block diagram of an example of components that may be present in a computing node 750 for implementing the techniques (e.g., operations, processes, methods, and methodologies) described herein. This computing node 750 provides a closer view of the respective components of node 700 when implemented as or as part of a computing device (e.g., as a mobile device, a base station, server, gateway, etc.). The computing node 750 may include any combinations of the hardware or logical components referenced herein, and it may include or couple with any device usable with a communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the computing node 750, or as components otherwise incorporated within a chassis of a larger system.

The computing device 750 may include processing circuitry in the form of a processor 752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, California. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the computing node 750 may communicate with close devices, e.g., within about 10 meters, using a local transceiver based on Bluetooth Low Energy (BLE), or another low power radio, to save power. More distant connected devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the cloud 795 via local or wide area network protocols. The wireless network transceiver 766 may be a low-power wide-area (LPWA) transceiver that follows the IEEE 802.15.4, or IEEE 802.15.4g standards, among others. The computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the cloud 795 or to other devices, such as the connected devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The computing node 750 may include or be coupled to acceleration circuitry 764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific computing tasks for service management and service operations discussed elsewhere in this document.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the computing node 750 to actuators 774, such as power switches, valve actuators, an audible sound generator, a visual warning device, and the like.

In some optional examples, various input/output (I/O) devices may be present within or connected to, the computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the computing node 750. A display or console hardware, in the context of the present system, may be used to provide output and receive input of a computing system; to manage components or services of a computing system; identify a state of a computing component or service; or to conduct any other number of management or administration functions or service use cases.

A battery 776 may power the computing node 750, although, in examples in which the computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the computing node 750. A wireless battery charging circuit, such as an LTC4020 chip from Linear Technologies of Milpitas, California, among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together but may comprise disparate instructions stored in different locations which, when joined logically together (e.g., including over a wire, over a network, using one or more platforms, wirelessly, via a software component, or the like), comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center) than that in which the code is deployed (e.g., in a computer embedded in a sensor or robot). Similarly, operational data may be identified and illustrated herein within components or modules and may be embodied in any suitable form and organized within any suitable type of data structure. The operational data may be collected as a single data set or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Each of these non-limiting examples may stand on its own, or may be combined in various permutations or combinations with one or more of the other examples.

Example 1 is at least one machine-readable medium including instructions, which when executed by processing circuitry, cause the processing circuitry to perform operations to: identify a current context of a robotic device, the current context including identification of at least one object present in a field of view; determine from the current context, a set of actions performable by the robotic device corresponding to the at least one object, the set of actions including one or more affordances generated from a basic skills library for the robotic device; automatically select an action of the set of actions based on an acyclic graph describing action paths; and output control signals that cause the robotic device to perform the action to interact with the at least one object.

In Example 2, the subject matter of Example 1 includes, wherein the basic skills library includes one or more dynamic movement actions including at least one of grasping an object, moving an object, or releasing an object.

In Example 3, the subject matter of Examples 1-2 includes, wherein the current context includes identification of all objects that are in a field of view, a trajectory of the robotic device, and a task to be completed.

In Example 4, the subject matter of Examples 1-3 includes, wherein the operations further include operations to receive user confirmation of the action before outputting the control signals.

In Example 5, the subject matter of Examples 1-4 includes, wherein the set of actions are generated by automatically extracting tasks from videos captured of the robotic device.

In Example 6, the subject matter of Examples 1-5 includes, wherein the robotic device is controlled using a gesture via an augmented reality interface, and wherein the current context includes identification of the gesture.

In Example 7, the subject matter of Examples 1-6 includes, wherein the operations to automatically select the action of the set of actions include operations to determine that two or more actions of the acyclic graph are selectable based on the current context, and select the action based on a probability of each of the two or more actions.

In Example 8, the subject matter of Examples 1-7 includes, wherein the action is a contingent action based on a previously performed action by the robotic device.

Example 9 is at least one machine-readable medium, including instructions, which when executed by processing circuitry, cause the processing circuitry to perform operations to: generate a basic skill library of primitives performable by a robotic device; automatically extract a set of affordances for at least one object from video data of the at least one object being manipulated; identify a task to be completed by the robotic device, including the at least one object involved in the task; generate an acyclic affordance graph for the task based on the set of affordances for the at least one object; and output the acyclic affordance graph to generate a suggested action for the robotic device in completing the task.

In Example 10, the subject matter of Example 9 includes, wherein the set of affordances are specific to a position or an orientation of the at least one object.

In Example 11, the subject matter of Examples 9-10 includes, wherein the acyclic affordance graph includes at least one action that is only available after at least one other action has been completed.

In Example 12, the subject matter of Examples 9-11 includes, wherein the acyclic affordance graph includes weights assigned to respective affordances of the acyclic affordance graph.

Example 13 is an apparatus comprising: means for identifying a current context of a robotic device, the current context including identification of at least one object present in a field of view; means for determining, using processing circuitry, from the current context, a set of actions performable by the robotic device corresponding to the at least one object, the set of actions including one or more affordances generated from a basic skills library for the robotic device; means for automatically selecting, using the processing circuitry, an action of the set of actions based on an acyclic graph describing action paths; and means for outputting control signals that cause the robotic device to perform the action to interact with the at least one object.

In Example 14, the subject matter of Example 13 includes, wherein the basic skills library includes one or more dynamic movement actions associated with at least one of: grasping the at least one object, moving the at least one object, or releasing the at least one object.

In Example 15, the subject matter of Examples 13-14 includes, wherein the current context includes information corresponding to an identification of all objects that are in the field of view, a trajectory of the robotic device, and a task to be completed.

In Example 16, the subject matter of Examples 13-15 includes, means for receiving user confirmation of the action before outputting the control signals.

In Example 17, the subject matter of Examples 13-16 includes, wherein the set of actions are generated by automatically extracting tasks from video or image data captured of the robotic device.

In Example 18, the subject matter of Examples 13-17 includes, wherein the robotic device is controlled using a gesture via an augmented reality interface, and wherein the current context includes identification of the gesture.

In Example 19, the subject matter of Examples 13-18 includes, wherein automatically selecting the action of the set of actions includes determining that two or more actions of the acyclic graph are selectable based on the current context, and selecting the action based on a probability of each of the two or more actions.

In Example 20, the subject matter of Examples 13-19 includes, wherein the action is a contingent action based on a previously performed action by the robotic device.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks), memory cards or sticks, random access memories (RAMs), read only memories (ROMs), and the like.

What is claimed is:

1. At least one machine-readable medium including instructions, which when executed by processing circuitry, cause the processing circuitry to perform operations to:
identify a current context of a robotic device, the current context including identification of at least one object present in a field of view;
determine from the current context, a set of actions performable by the robotic device corresponding to the at least one object, the set of actions including one or more affordances generated from a basic skills library for the robotic device;
automatically select an action of the set of actions based on an acyclic graph describing action paths; and
output control signals that cause the robotic device to perform the action to interact with the at least one object.

2. The at least one machine-readable medium of claim 1, wherein the basic skills library includes one or more dynamic movement actions including at least one of grasping an object, moving an object, or releasing an object.

3. The at least one machine-readable medium of claim 1, wherein the current context includes identification of all objects that are in a field of view, a trajectory of the robotic device, and a task to be completed.

4. The at least one machine-readable medium of claim 1, wherein the operations further include operations to receive user confirmation of the action before outputting the control signals.

5. The at least one machine-readable medium of claim 1, wherein the set of actions are generated by automatically extracting tasks from videos captured of the robotic device.

6. The at least one machine-readable medium of claim 1, wherein the robotic device is controlled using a gesture via an augmented reality interface, and wherein the current context includes identification of the gesture.

7. The at least one machine-readable medium of claim 1, wherein the operations to automatically select the action of the set of actions include operations to determine that two or more actions of the acyclic graph are selectable based on the current context, and select the action based on a probability of each of the two or more actions.

8. The at least one machine-readable medium of claim 1, wherein the action is a contingent action based on a previously performed action by the robotic device.

9. At least one machine-readable medium, including instructions, which when executed by processing circuitry, cause the processing circuitry to perform operations to:
generate a basic skill library of primitives performable by a robotic device;
automatically extract a set of affordances for at least one object from video data of the at least one object being manipulated;
identify a task to be completed by the robotic device, including the at least one object involved in the task;
generate an acyclic affordance graph for the task based on the set of affordances for the at least one object; and
output the acyclic affordance graph to generate a suggested action for the robotic device in completing the task.

10. The at least one machine-readable medium of claim 9, wherein the set of affordances are specific to a position or an orientation of the at least one object.

11. The at least one machine-readable medium of claim 9, wherein the acyclic affordance graph includes at least one action that is only available after at least one other action has been completed.

12. The at least one machine-readable medium of claim 9, wherein the acyclic affordance graph includes weights assigned to respective affordances of the acyclic affordance graph.

13. An apparatus comprising:
means for identifying a current context of a robotic device, the current context including identification of at least one object present in a field of view;
means for determining, using processing circuitry, from the current context, a set of actions performable by the robotic device corresponding to the at least one object, the set of actions including one or more affordances generated from a basic skills library for the robotic device;
means for automatically selecting, using the processing circuitry, an action of the set of actions based on an acyclic graph describing action paths; and
means for outputting control signals that cause the robotic device to perform the action to interact with the at least one object.

14. The apparatus of claim 13, wherein the basic skills library includes one or more dynamic movement actions associated with at least one of: grasping the at least one object, moving the at least one object, or releasing the at least one object.

15. The apparatus of claim 13, wherein the current context includes information corresponding to an identification of all objects that are in the field of view, a trajectory of the robotic device, and a task to be completed.

16. The apparatus of claim 13, further comprising means for receiving user confirmation of the action before outputting the control signals.

17. The apparatus of claim 13, wherein the set of actions are generated by automatically extracting tasks from video or image data captured of the robotic device.

18. The apparatus of claim 13, wherein the robotic device is controlled using a gesture via an augmented reality interface, and wherein the current context includes identification of the gesture.

19. The apparatus of claim 13, wherein automatically selecting the action of the set of actions includes determining that two or more actions of the acyclic graph are selectable based on the current context, and selecting the action based on a probability of each of the two or more actions.

20. The apparatus of claim 13, wherein the action is a contingent action based on a previously performed action by the robotic device.
